(19) United States
(12) Patent Application Publication
(10) Pub. No.: US 2007/0150520 A1
(43) Pub. Date: Jun. 28, 2007

(54) User defined event rules for aggregate fields

(75) Inventors: Brian Elgaard Bennett, Virum (DK); Flemming Wang Tommerby, Lynge (DK); Søren Printz Christensen, Copenhagen (DK)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/297,759

(22) Filed: Dec. 8, 2005

(51) Int. Cl. G06F 17/30

(52) U.S. Cl. 707/200

(57) ABSTRACT

Enterprise resource planning systems can be configured to help businesses keep track of events that could affect one or more supply chains. A key purpose for such a system is to ensure a smooth flow of goods or services from suppliers to purchasers. One way to help ensure that the supply chain is efficiently maintained is to set alerts when events occur. However, alerts are usually not flexible or as easy to use as users would like. An apparatus and methods are provided for facilitating the creation and use of user-defined event rules for aggregate fields. Aggregate fields are defined by a user, who can also define one or more rules relative to the aggregate field.

### BACKGROUND

Enterprise resource planning systems can be configured to help businesses keep track of events that could affect one or more supply chains. A key purpose for such a system is to ensure a smooth flow of goods or services from suppliers to purchasers. One way to help ensure that the supply chain is efficiently maintained is to set alerts when events occur. However, alerts are usually not flexible or as easy to use as users would like.

The discussion above is merely provided for general background information and is not intended for use as an aid in determining the scope of the claimed subject matter.

### SUMMARY

User-defined events are provided for aggregate fields. Aggregate fields include any data that is calculated based on a function of a plurality of fields in one or more tables. The user can provide selection criteria, and a function to apply to contents of fields that satisfy the selection criteria. The user can define one or more rules that can fire based on criteria relative to the aggregate field. An alert can be generated as a result of a rule firing. A method for providing selective alert generation relative to an aggregate field is provided. Additionally, a computer-implemented method for generating a user-defined event relative to an aggregate rule is also provided. Further, a computer-readable medium having a data structure for facilitating aggregate fields is also provided.

This Summary is provided to introduce, in a simplified form, a selection of concepts that are further described below in the Detailed Description. This Summary is not intended to identify key features or essential features of the claimed subject matter, nor is it intended for use as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one computing environment in which some embodiments may be practiced.

FIG. 2 is a flowchart of a method for creating alerts in a database system.

FIG. 3 is an illustration of a display component for selecting a field or record to be monitored using a monitoring rule.

FIG. 4 is an illustration of a form used to create a monitoring rule.

FIG. 5 is an illustration of a display that enables all or some alert rules to be viewed or reviewed.

FIG. 6 is a schematic diagram demonstrating system flow.

FIG. 7 is a schematic illustration demonstrating a functionality that enables rules to be created.

FIG. 8 is a schematic illustration demonstrating how events can be recorded.

FIG. 9 is a diagrammatic view of an aggregate field encompassing a plurality of fields in accordance with one embodiment.

FIG. 10 is a diagrammatic view of an aggregate field encompassing a plurality of fields in accordance with another embodiment.

FIG. 11 is a flow diagram of a method of processing selectively generating an alert in response to an atomic change relative to an aggregate field in accordance with an embodiment.

FIG. 12 is a computer-implemented method of generating a user-defined event relative to an aggregate field in accordance with an embodiment.

FIG. 13 is a computer-readable medium having a data structure stored thereon in accordance with an embodiment.

FIG. 14 is a schematic diagram illustrating an alert inbox and a process of drilling down.

### DETAILED DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

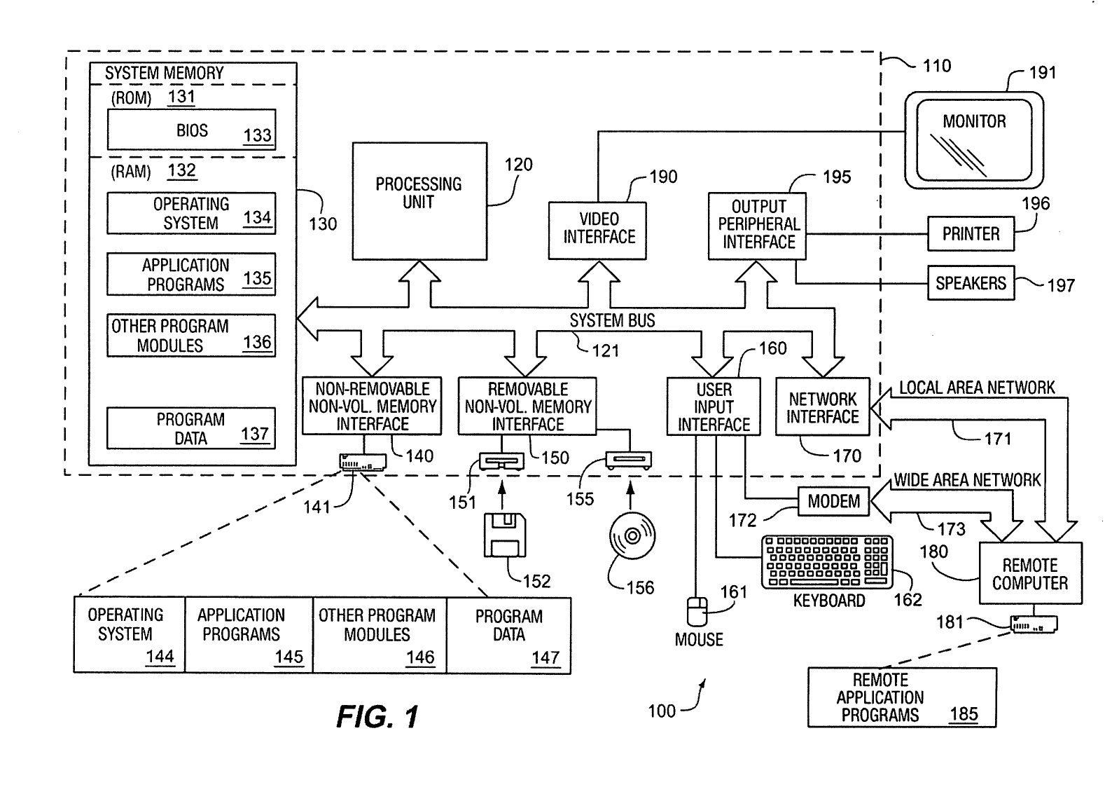

FIG. 1 illustrates an example of a suitable computing system environment 100 with which embodiments can be implemented. The computing system environment 100 is only one example of a suitable computing environment and is not intended to suggest any limitation as to the scope of use or functionality of the method of apparatus of the claims. Neither should the computing environment 100 be interpreted as having any dependency or requirement relating to any one or combination of components illustrated in the exemplary operating environment 100.

Embodiments are operational with numerous other general purpose or special purpose computing system environments or configurations. Examples of well known computing systems, environments, and/or configurations that may be suitable for use with the methods or apparatus of the claims include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. The methods and apparatus may also be applied within distributed computing environments where tasks are performed by remote processing devices that are linked through a communications network. In a distributed computing environment, program modules may be located in both local and remote computer storage media including memory storage devices.

With reference to FIG. 1, an exemplary system for implementing the at least some embodiments includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and non-volatile media, removable and non-removable media. By way of example, and not limitation, computer readable media may comprise computer storage media and communication media. Computer storage media includes both volatile and non-volatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable, volatile/nonvolatile computer storage media. By way of example only, FIG. 1 illustrates a hard disk drive 140 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and pointing device 161, commonly referred to as a mouse, trackball or touch pad. Other input devices (not shown) may include a microphone, joystick, game pad, satellite dish, scanner, or the like. These and other input. devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 1. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on memory device 181. It will be appreciated that the network connections shown are exemplary and other means of establishing a communications link between the computers may be used.

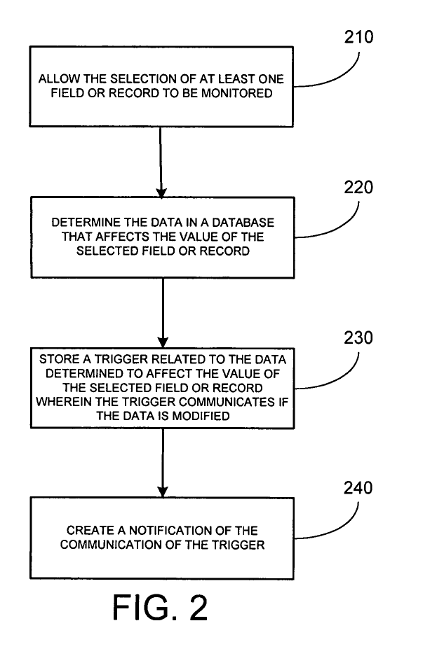

FIG. 2 is a flowchart of a method for creating alerts in a database system. Initially, a list of fields or records in at least one form that may be monitored is illustratively created. A form may be a business form such as a purchase order, a request for proposal, an invoice, et cetera. Each form may have fields or records such as a quantity field, a price field, an amount shipped field, et cetera. The fields or records may be used in several forms. Other fields or records may be only used in one or a few forms. For example, an invoice number field may be used on a few forms.

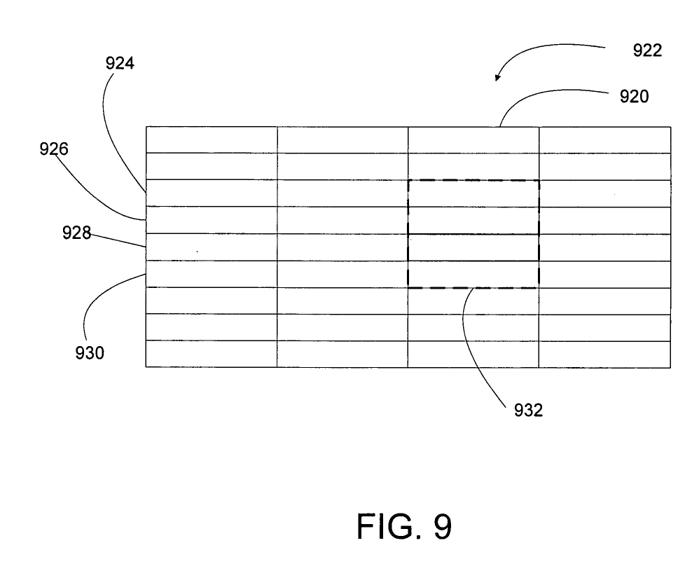

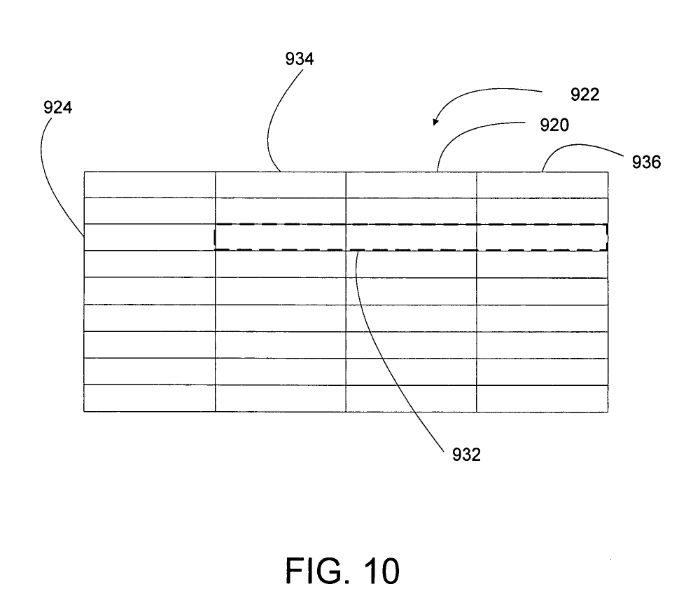

At block 210, the selection of one or more fields or records to be monitored from a form used to display the fields or records is illustratively permitted. For example, a user may select the “amount shipped” field. The user can also select an aggregate field based on one or more fields. An example of an aggregate field is a sum of a given field for a selected set of records. Aggregate fields will be discussed in greater detail below with respect to FIGS. 9 and 10. The selection of the field, or aggregate field may occur in a variety of ways. A user may right click on the field or aggregate field, which may create a pop-up menu of options, including an option to select the field or aggregate field to be monitored. The user also may use a drop down menu to select one of a plurality of fields in a form to be monitored.

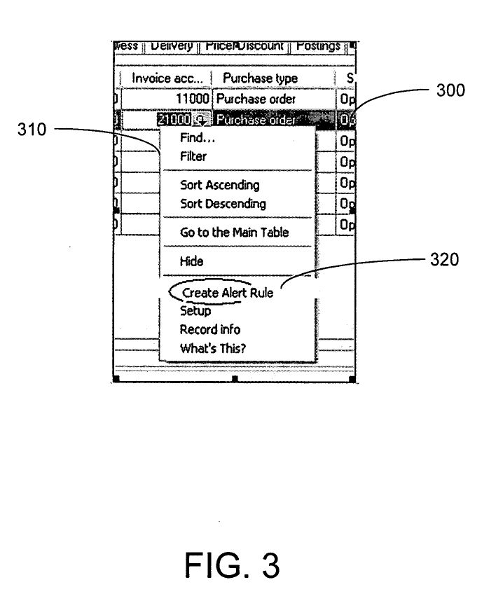

FIG. 3 illustrates one example of a display for selecting a field to be monitored using a monitoring rule. In this example display, the purchase order record 300 is selected and various options are then presented in a pop-up window 310, including a creating a rule alert option 320. Other methods such as the input of codes or having the selection occur via another software module can also be practiced in accordance with various embodiments.

Monitoring the field, record, or aggregate field can be done in a number of ways. The monitoring may entail watching whether a value changes, whether it increases, whether it decreases, whether it increases beyond a set amount, whether it has been accessed, et cetera. These are just examples of many potential different grounds for monitoring.

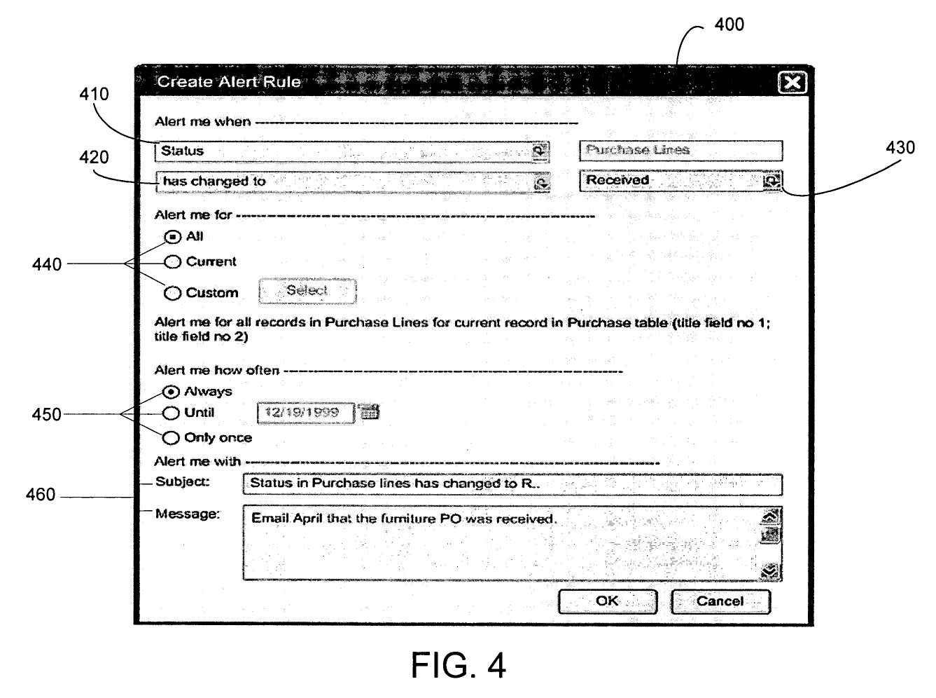

FIG. 4 is an illustration of a form 400 used to create a monitoring rule. Assuming that a field has been selected, a rule illustratively allows conditions to be set for when an alert is created based on this field. Monitoring functionality associated with the illustrated event type 410, change status 420 and parameter 430 can be thought of as a comparison between a before value and an after value of the field (in the illustrated case, the before value is not specifically designated). An alert is created when the value has changed (e.g., increased, decreased, changed to a certain value, etc.) in a predetermined and prescribed manner. The comparison parameter 430 can be thought of as a condition such that an alert is only created when the comparison of the before and after values crosses the prescribed boundary (e.g. the before value is less than 10 and the after value is greater than 10. A filter 440 can be considered a further condition such that an alert is only created when the record in which the change happened and related records meet certain static criteria (e.g. the Country field must be equal to Germany). Alert receipt preferences 450 may be thought of as one or more further conditions such that an alert will only be created when it is convenient for the recipient to receive it (e.g., only the first time all the other conditions are met, but not the second time). Beyond the conditions for when the alert will be created, FIG. 4 also illustrates details of how the alert may be delivered such as with an email 460 with a certain subject and a certain message. The message may be automatically generated by the method and a user may be permitted to modify the message.

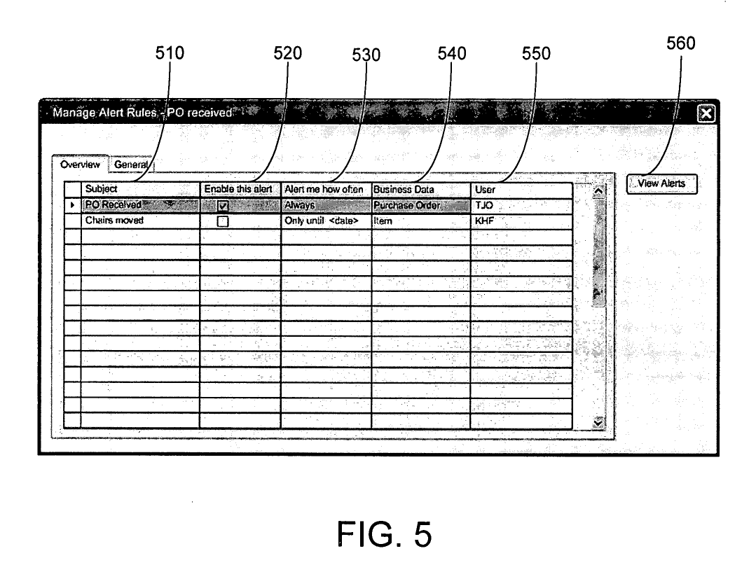

FIG. 5 is an illustration of a display wherein all or some of the alert rules may be viewed. This display option may be available, for example, as part of the Tools menu. The created rules may be arranged by subject 510, whether the alert is enabled 520, how often the alert is to be communicated 530, the business data to be monitored 540, the user that should be alerted 550, or based on some other parameter. There may also be an option 560 to view all the alerts that have been triggered. In one embodiment, any of the displayed rules may be modified as desired by selecting and modifying a particular row-and column.

At block 220, the data in a database that affects the value of the selected field may be determined. The value in the selected field(s) or aggregate field may be a calculated value based on a number of entries in a database. For example, a report of accounts receivable may pull data from a variety of database fields. Accordingly, block 220 may include determining which entries affect a selected field.

For example, in ERP applications there may be joins or combinations of fields that are used in forms to represent a number of records as a single record to the user. One “form record” may be the result of a join between n tables as is illustrated in the following diagram:

[image]

Often the user does not know that he or she is viewing joined data from more than one table. The user may expect to be creating a rule for the master or result of the join even though the actual monitoring of changes to data in the database potentially is being done for several of the involved tables. An example of a data set that may consist of joined data sources is a Sales Order Line. This data set may incorporate a join between tables “SalesLine” and “InventDim”. The user may see this data set as one record: A sales Order Line.

Another example may be an Item. An Item form may display a data set which is the result of a join between five data sources divided over three tables: “InventTable”,“InventTableModule” and “InventItemLocation” (One record from InventTable is joined to three different records in InventTableModule and furthermore the record is joined to a record in InventItemLocation). However, the user may see this data set as one record: An Item.

Following is a diagram demonstrating a join scenario:

[image]

The diagram above demonstrates how tables A,B,C and D may be joined together. A1 joints to B1. B2 joins to C1. C2 joins to D1 The following rule setup scenarios explain how additional data-change monitoring (e.g., in the DatabaseLog table) may be applied when rules are set up for fields on each of the four tables:
1. Setting up a Rule for a Field ‘A56’

In this case, no changes to data in tables B, C or D may affect what the user sees as changes in the field to which the rule applies. Conclusion: Only data changes for field ‘A56’ require monitoring.
2. Setting up a Rule for Field ‘B34’

In this case a change to field ‘A1’ may potentially affect what the user will see in field ‘B34’ because the change in the join criteria ‘A1’ may cause a different record to be joined into the dataset.

Conclusion: Monitoring of data changes is required for both ‘A1’ and ‘B34’.

3. Setting up a Rule for Field ‘C12’

In this case a change to field ‘A1’ or a change to field ‘B2’ may potentially affect what the user will see in field ‘C12’. In this scenario a different B-record may be joined into the data set if ‘A1’ is changed and a different C-record may be joined into the data set if ‘B2’ is changed. Conclusion: Monitoring of data changes is required for ‘A1’, ‘B2’ and ‘C12’.
4. Setting up a Rule for Field ‘D17’

In this case a change to field ‘A1’ or a change to field ‘B2’ or a change to field ‘C2’ may potentially affect what the user will see in field ‘D17’. In this scenario, a different B-record may be joined into the data set if ‘A1’ is changed and a different C-record may be joined into the data set if ‘B2’ is changed and a different D-record may be joined into the data set if ‘C2’ is changed. Conclusion: Monitoring of data changes is required for ‘A1’, ‘B2’, ‘C2’ and ‘D17’.

Consistent with the four scenarios above, a general approach can be defined. For example, if a rule is set up for a table in the context of a joined data set in a form, then all the fields used as join criteria from parent to child for all upper data sources in the joined statement should be monitored.

Referring again to FIG. 2, at block 230, a trigger related to the data determined to affect the value of the selected field or record may be stored. The trigger illustratively effectuates a communication if the corresponding data is accessed. Other data may be accessed to create the data, read the data, update the data or delete the data. The trigger may require the accessed data to be stored in a separate database table that is polled. The accessed data may also be immediately reported.

At block 240, a notification of the communication of the trigger field may be created. The notification may be created virtually immediately once access to data that affects the field or record has occurred or the notification may take place once the system has periodically polled accessed data.

The method may also allow a user to view the selected field or record in a form by selecting the notification of the communication of the trigger. For example, if a notification of the total accounts receivable over 120 days old was created using an accounts receivable report, the report may be used to display the account receivable total over 120 days. The method may also have default forms associated with fields or records. For example, if the total accounts receivable field has been selected to be monitored, the method may display the changed total accounts receivable field in the default accounts receivable report. Once the notification of the communication of the trigger has been communicated, a variety of things may occur. The communication may simply be deleted. The communication may present an option to modify the monitoring. For example, if a dollar limit is set for monitoring the total accounts receivable, the dollar limit may be raised.

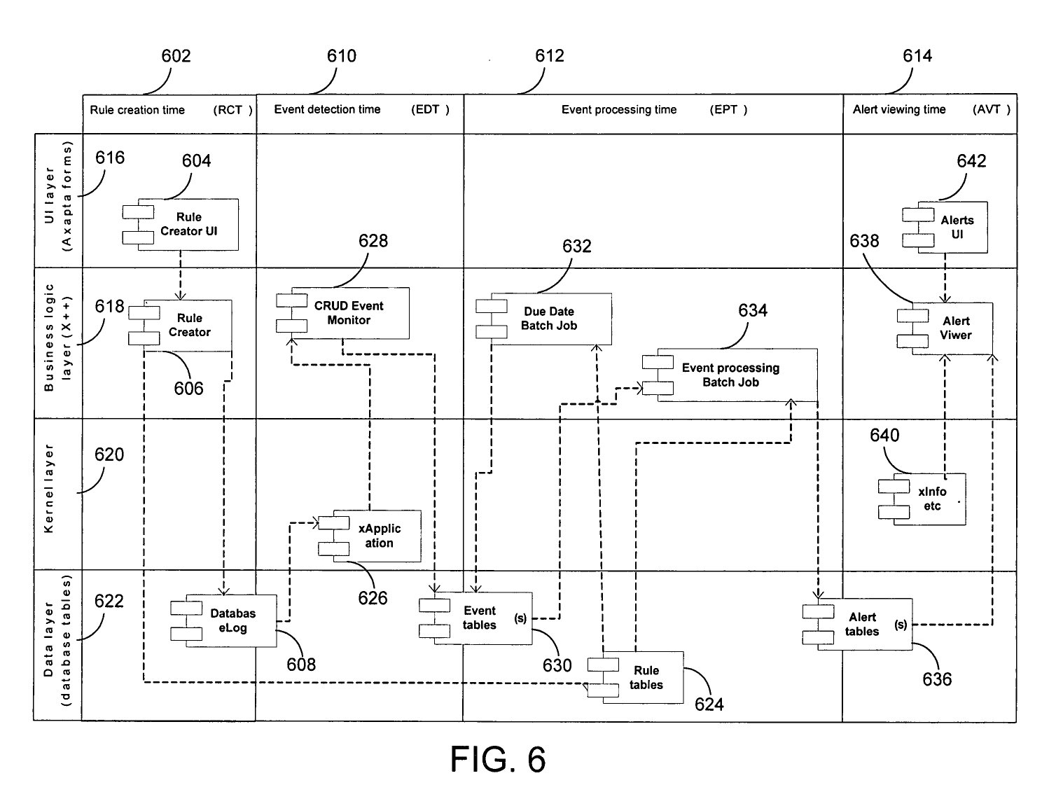

FIG. 6 is a block diagram of related system flow. In general, events are generated based on database records being created, read, updated or deleted, and when a database date field is n days from today. For an update event, the previous value may be used (i.e., the value of the record being updated) in order to implement field change events. Field or record change events may include increased, increased above x, etc. For scheduled events this may not be possible as only the current value will be available. These database events may be brought to a level that users can relate to by allowing rules to be setup from a context on a familiar form. For example, when right-clicking a field on a form, user defined events may extract context, including current field/table, joined in tables, active filter and parent, when possible.

In FIG. 6, the leftmost column, Rule Creation Time of the diagram illustratively contains modules used to create rules; such as the Rule Creator User Interface 604, Rule Creator 606 and the Database log 608 which will be described further below. The Event time detection 610 and Event processing time 612 columns illustratively contain modules used to record that change/update/delete events happen, and to process change, read, update and delete CRUD and date driven events which will be described further below. The rightmost column, alert viewing time 614, illustratively contains modules used to view and drill-down into alerts, which are also described below (The Alert Inbox and Drill-Down section). The rows illustratively describe the different layers of the system that are involved in the process starting at the user interface layer 616, then the business logic layer 618, then the kernel layer 620, and finally the data layer 622, where the database tables are located.

The flow starts at the rule creator user interface 604 within the user interface layer 616. The user selects a field or record to monitor. In the business logic layer 618, the rule creator 606 interprets the user's selection into the underlying database fields that affect the selected field or record. The rule creator 606 saves the resulting rules in a rules table 624 within the database layer 622. The rule creator 606 may also communicate with the database log 608 to set triggers on the relevant database fields. The database log 608 communicates with a class in the kernel 626, which illustratively operates in the kernel layer 620. The class in the kernel 626 communicates with the CRUD event monitor 628, which illustratively operates in the business logic layer 618. The CRUD event monitor keeps track of CRUD events, which are illustratively stored in event tables 630. Update events illustratively affect fields. Create, read or delete events illustratively affect records.

The rule creator 606 may also communicate with the rule tables 624, which illustratively operate in the database layer 622. The rules tables 624 store all the created rules in a table. The rule table 624 communicates with a due date batch job block 632, which illustratively operates in the business logic layer 618. The due date batch job block 632 periodically applies the rules that are date driven, such as whether an invoice has not been paid in 120 days, for example. The results of the due date batch job block 632 are communicated and stored in the event table 630. In another embodiment, the due date batch job block 632 communicates with the alert tables 636.

Both the event table 630 and the rule table 624 communicate to the event processing batch job block 634, which illustratively operates in the business logic layer 618. The event tables 630 and the rule table 624 communicate with the event processing batch job such that when events occur in the business logic layer 618, alerts will be generated. The events processing batch job 634 communicates with an alert table 636, which is illustratively in the database layer 622. The alert tables 636 illustratively keep track of events that have been triggered. The alert tables 636 may be in communication with the alert viewer 638, which is illustratively in the business logic layer 618. Software application information 640 from the kernel layer 620 may also be communicated to the alert viewer 638. An alert user interface 642 communicates to the alert viewer 638.

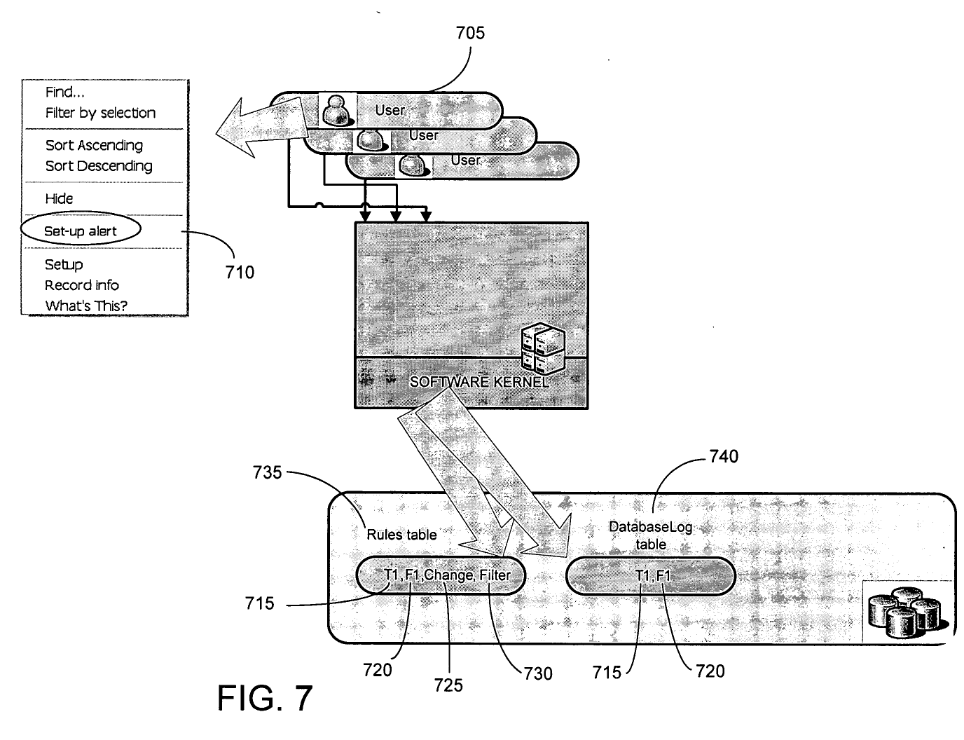

FIG. 7 is a schematic diagram demonstrating an ability to create rules on business data currently on-screen, meaning database fields exposed on forms. In this example there may be a number of servers that run a number of clients. A client 705 indicates an interest in changes to a field or record on the Purchase Order form by right-clicking on the field and selecting Set-Up Alert 710. The application software, such as a CRM system, will detect from the context, the table (T1) 715, the field (F1) 720, the change (if any) 725 and any currently defined filter 730. Clients may have the option to change what has been deduced from the context or to leave it as is. This information is saved in the rules table 735 and in addition to this the kernel table, a database log 740 is updated with table 715 and field 720 information as well.

In one embodiment, a day-to-day user is only allowed to create rules for his or her self. However, administrators may be able to manage other user's rules. In addition to this, day-to-day users may use the built-in functionality to create a template based on a rule; while other users may be able use such a template to create additional rules.

Change, read, update and delete (“CRUD”) events may be recorded by subscribing to the software kernel's database log functionality; information passed from the kernel when a CRUD event occurs. The CRUD event may be saved in the events table as part of the currently running transaction. This database table may be processed by the event processing batch job, which may run each rule on matching events. To see if a rule matches an event, the event processing batch job may compare source (table, field) and field change specification for rules and events. Before a rule may be run it is checked if the associated user has access to the changed data; if not, the rule will not be run. A rule may be run by executing a corresponding filter setup. An action will be communicated or fired if the result of the query matches the record of the event. Note that before running the query it may have user access criteria for the associated user merged in, so that a user may only get alerted on data accessible to a user. The action available to end users may be to save alert information to the alert inbox table.

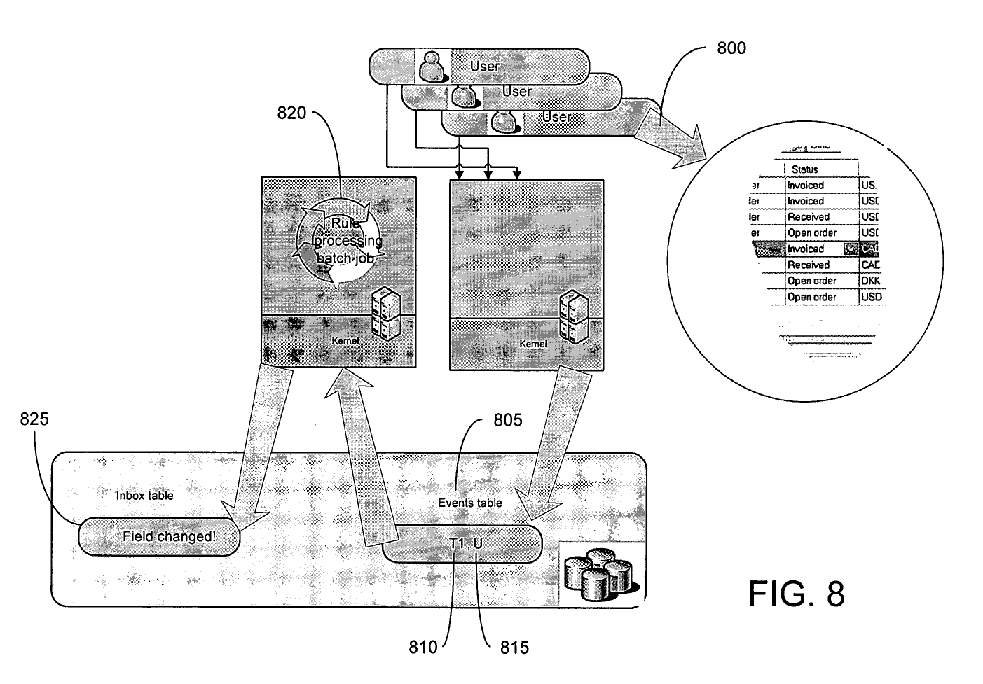

FIG. 8 is an illustration of a display demonstrating how change/update/delete events may be recorded. In this example, a client may have changed data in a field in a Purchase Order form 800. The method may record to the events table 805 that a record in table T1 810 has been updated 815. A short while later, the event processing batch job 820 may kick in or begin to consume all events recorded to the events table. If it turns out that the event matches the rule set up earlier (a record in the table T1 was updated and the field F1 changed its value—and the filter matched as well), the alert inbox table of that client may be updated 825.

FIG. 9 is a diagrammatic view of an aggregate field encompassing a plurality of records in accordance with an embodiment. The selection of the aggregate field can be done in accordance with any suitable method, including those listed above. In general, a user is provided with the ability to indicate or select between a record or a field. Once the indication is received, the user can be prompted to select the criteria for the record or field. Selecting can include explicitly selecting a plurality of records or fields, such as by entering specific field or record labels, dragging a cursor over a plurality or records or fields, or any other suitable method. Further, embodiments can be practiced where a database groups records, and then a sum, or other suitable function, is performed of a field over the records for each group. As an example, if the user enters selection criteria that can be satisfied by more than one record or field, then the user has essentially specified an aggregate record or field. In FIG. 9, the user has selected field 920 in table 922. When prompted to provide selection criteria for the record(s), the user entered criteria that were satisfied by records 924, 926, 928, and 930. An example of this would be where a user selects or indicates that he or she wants to generate an alert based on a field such as “purchase price.” Then the system generates a display that allows the user to select the field among all possible fields. Once the user has selected the “purchase price” field, he or she is presented with an interface for generating selection criteria. One example of selection criteria can include all records where the sale occurred after September 2004. Selection criteria can be specified relative to one or more fields of the records, which fields may or may not include the aggregated field. Moreover, the user can indicate any suitable Boolean operators relative to the selection criteria including, but not limited to, equals, does not equal, is greater than, is less than, and any suitable combination thereof. Among the selected records, the aggregate field can be any suitable function, such as a sum, or an average of the contents of the grouped fields or records. In the example shown in FIG. 9, the user's criteria has been satisfied by records 924, 926, 928 and 930 generating aggregate field 932, which may be, for example, an average price for all sales occurring after September 2004.

FIG. 10 is a diagrammatic view of an aggregate field encompassing a plurality of field of a given record in accordance with an embodiment. The selection of the aggregate field can be done in accordance with any suitable method, including those listed above. In FIG. 10, the user has selected record 924 in table 922. When prompted to provide selection criteria for the field(s), the user entered criteria that were satisfied by fields 934, 920, and 936. An example of this would be where a user selects indicates that he or she wants to generate an alert based on an aggregated field such as the total sales, for a given record, for pacific, mountain, and midwest regions. Then the system generates a display that allows the user to select the record among all possible records. Once the user has selected the record, he or she is presented with an interface for generating field selection criteria. One example of selection criteria can include region equals pacific; region equals mountain; or region equals midwest. The user can indicate any suitable Boolean operators relative to the selection criteria including, but not limited to, equals, does not equal, is greater than, is less than, and any combination thereof. Among the selected records, the aggregate field can be any suitable function, such as a sum, or an average of the values in the selected fields.

One concern when providing user-defined events on aggregate fields is that a given atomic change (a change to the contents of a specific field of a specific record) may not, in fact, generate an alertable change with respect to the aggregate field. As set forth above, an example of an aggregate field is a sum of a given field over records that satisfy certain criteria and over a given grouping of records. One difficulty with the sum function is that the monitored field is essentially a virtual field in a pseudo record expressing the value from multiple records. When the value of an actual field is changed (atomic change), this change may or may not change the virtual (sum) field that a user may wish to receive events on relative to changes. Adding the to difficulty is the fact that a user may wish to not only be notified when the virtual or aggregate field changes, but also whether the aggregate field has increased or decreased above or below a selected threshold. Accordingly, an individual atomic change, in and of itself, does not provide enough information to provide effective event alerting.

One way that this situation is addressed in some embodiments, is suppressing further alerts for additional atomic changes when an aggregate field has passed the selected threshold. This suppression is maintained until the aggregate field returns to the threshold and passes it again. This state information is generally indicated by the setting and subsequent deletion of ignore records. In accordance with an embodiment, an ignore record is inserted for each unique combination of values of the fields that define the grouping. A set of ignore records is stored for each relevant event rule. An ignore record indicates the specific grouping to be ignored. Ignore records can be used to determine what future atomic events should be ignored for a given rule when the value of the aggregate field has increased above a certain threshold and is still above the threshold. Conversely, ignore records can be used to state what future atomic events should be ignored for a given rule when the value of the aggregate field has decreased below a certain threshold and is still below the threshold. Accordingly, if an ignore record exists for a given rule, the system knows that the rule has fired, and that it should not fire again until the value of the aggregate field crosses the threshold again. When the value of the aggregate field crosses the threshold again, the ignore records relative to the rule are deleted.

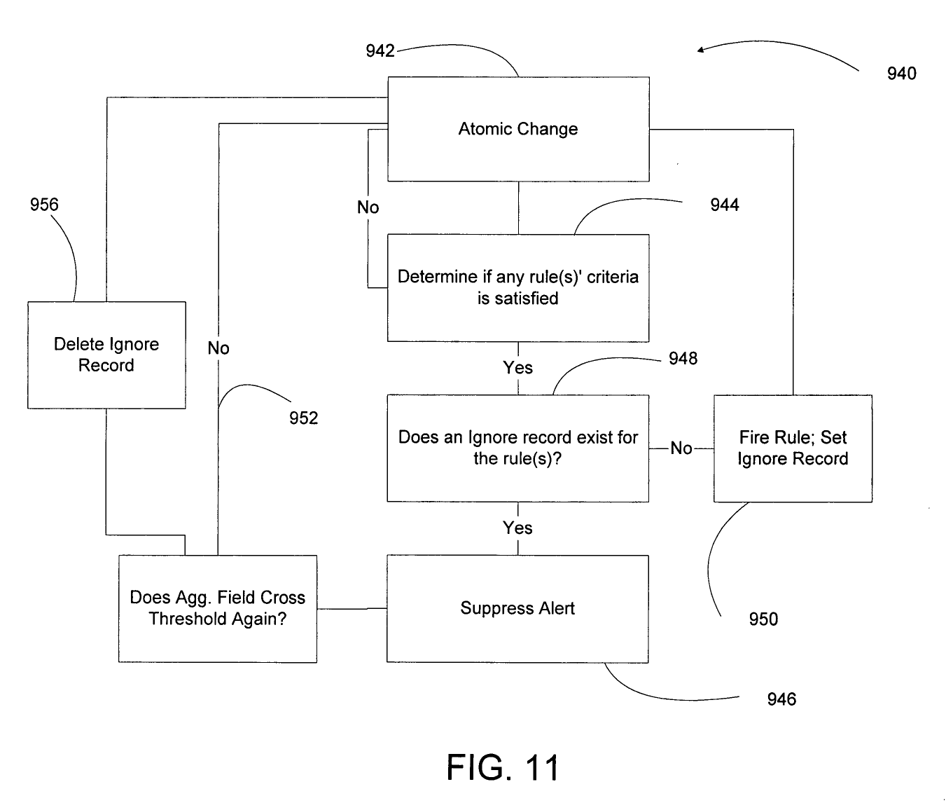

FIG. 11 is a flow diagram of a method of selectively generating an alert in response to an atomic change relative to an aggregate field in accordance with an embodiment. Method 940 begins at block 942 where an atomic change occurs and is reported to the enterprise resource planning system by the operating system. At block 944 the system determines whether the atomic change causes the aggregate field to satisfy at least one rule's criteria. If the aggregate field does not satisfy any rules' criteria, then control returns to block 942 and the method loops. If a rule's criteria for firing are satisfied, then the rule will fire unless the firing is to be suppressed, as indicated at block 946. One way in which the determination can be accomplished is by determining if an ignore record exists relative to the rule and grouping, as indicated at block 948. The rule's firing will be suppressed if the rule has fired based on the aggregate field passing a threshold, and the atomic change does not cause the threshold to be crossed again. At block 950, the rule selectively fires generating an alert, and also setting an ignore record for that rule. At block 952, the system determines whether the aggregate field crosses the threshold again as a result of the atomic change. If the answer is in the negative, then control returns along line 954 to block 942. However, if the answer is affirmative, then control passes to block 956 where the ignore record for the rule is deleted.

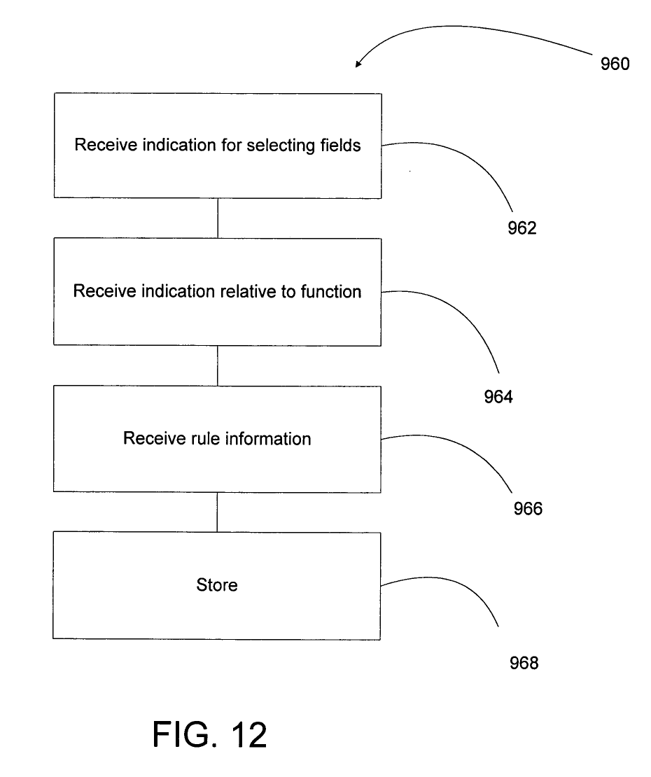

FIG. 12 is a computer-implemented method of generating a user-defined rule relative to an aggregate field in accordance with an embodiment. Method 960 begins at block 962 where a user's indication relative to selecting a plurality of fields is received. The indication can include criteria for selecting fields having values within a certain range, for example. The indication can also simply include an explicit selection of a plurality of fields from at least one table. The fields can be selected from a plurality of tables. At block 964, an indication is received from the user relative to the function to apply to the contents of the selected fields. For example, the user may indicate that the aggregate field will be the sum of the selected fields' contents. Receiving the indications illustrated with respect to blocks 962 and 964 can also be achieve if the user selects, or is otherwise focused upon, a given aggregate field, such as a sum, and the user right-clicks the sum. Upon receiving the right-click, the system will already know which fields are to be selected, and what function (sum) will be applied. At block 966, user rule information is received. Finally, at block 968, the field selection information, the function information, and the rule information are stored.

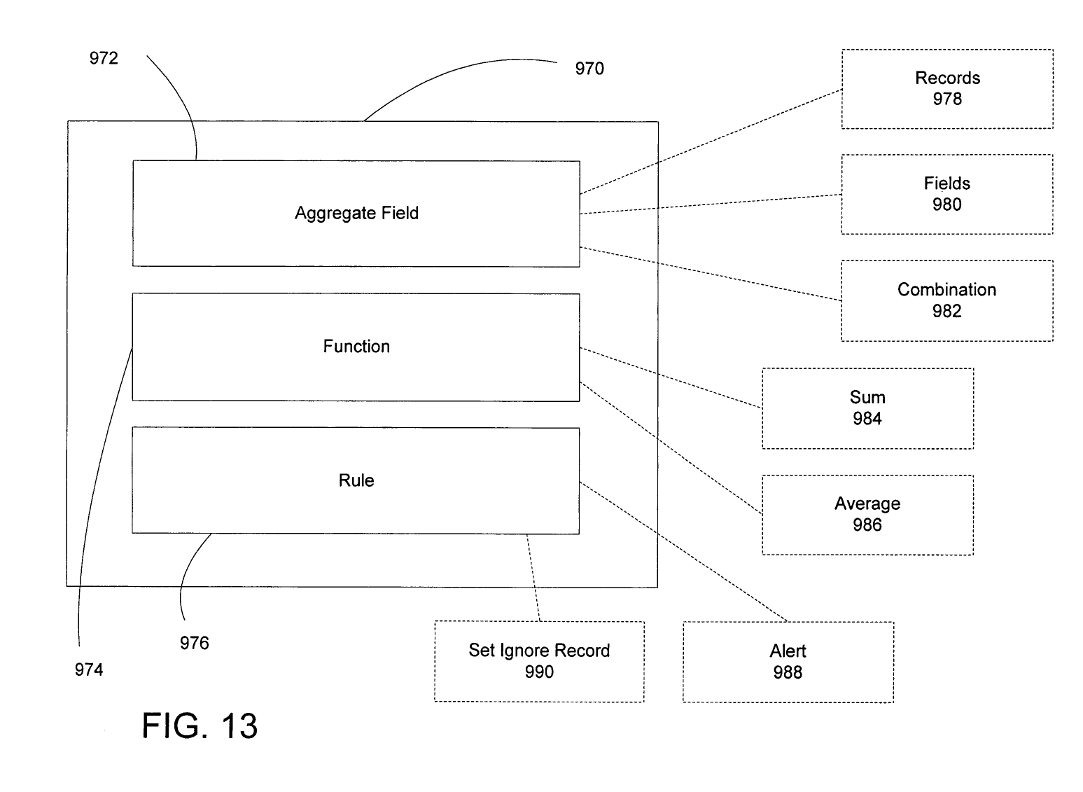

FIG. 13 is a computer-readable medium having a data structure stored thereon in accordance with an embodiment. Computer-readable medium 970 has data structures 972, 974 and 976 stored thereon. Data structure 972 includes an aggregate field portion indicating selection criteria for selecting a plurality of fields from at least one table. The selection criteria can be provided relative to a specific field of a plurality of records, as indicated at phantom block 978. The selection criteria can be provided relative to a plurality of fields of a single record, as indicated at phantom block 980. The selection criteria can be provided relative to a plurality of fields relative to a plurality of records, as indicated at phantom block 982. Function portion 974 indicates a function to apply to the selected field contents. For example, the function can be sum 984, average 986 or any other suitable function. Finally, rule structure 976 is configured to storing at least one rule relative to the aggregate field value and an action to generate when the rule fires. The action can be the generation of an alert 988 and the setting of an ignore record 990 to suppress further actions and/or alerts as may be appropriate.

When new alerts arrive into the alerts inbox, the user may be able to get a pop-up or attention grabber in the software application as well as a visual clue. For CRU (A CRU event is a CRUD event minus deletion; for deletions it makes no sense to drill-down as the business data in question has been deleted.) event based alerts, the method may allow a user to go from an alert in the alert inbox into a form that shows the current state of the business data in question. This may be referred to as drill-down. When possible, drill-down may go to the form on which the rule has been set up; and when this is not possible, drill-down may go to the default form for the master table of the rule. When neither forms are possible, the user may get an error message that drill-down is not possible.

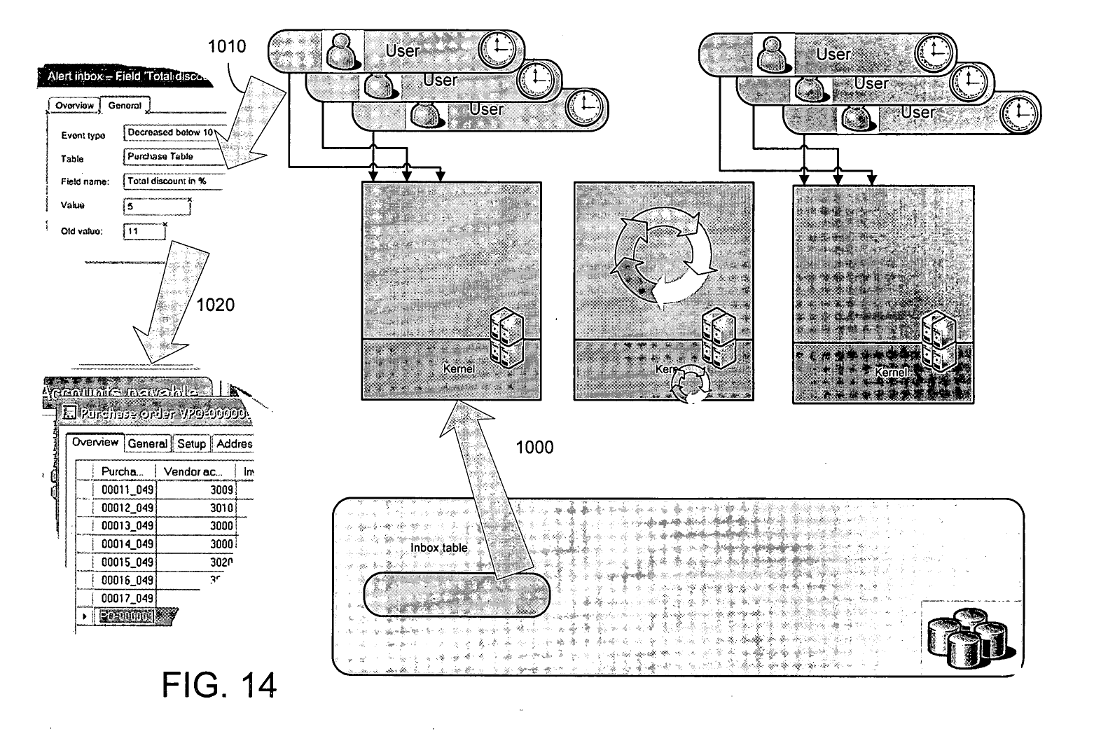

FIG. 14 is a schematic diagram illustrating an alert inbox and a process of drilling down. Each client process may monitor its alert inbox table in order to discover newly arrived alert information records 1000. When a new record is discovered, a pop-up may be shown and the alert information may be available in each client's inbox form 1010. From the inbox, it may be possible to drill-down to a form 1020. Note that the alert inbox is personal but it may contain alerts for a given user for all companies used by the user.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of generating an alert relative to an aggregate field, the method comprising:
receiving an indication of an atomic change to data relative to the aggregate field;
determining whether the atomic change causes the aggregate field to satisfy at least one rule criteria; and
selectively generating the alert based on whether the aggregate field satisfies at least one rule criteria.

2. The computer-implemented method of claim 1, wherein determining whether the atomic change causes the aggregate field to satisfy at least one rule criteria includes determining if the aggregate field passes a user-defined threshold.

3. The computer-implemented method of claim 2, wherein further alerts relative to the rule and grouping are suppressed until the aggregate field passes the user-defined threshold again.

4. The computer-implemented method of claim 3, and further comprising generating an ignore record relative to the rule and grouping when the user-defined threshold is first crossed.

5. The computer-implemented method of claim 4, and further comprising deleting the ignore record when the threshold is crossed again.

6. The computer-implemented method of claim 1, wherein the aggregate field is selected by a user.

7. The computer-implemented method of claim 1, wherein the rule is generated by a user.

8. The computer implemented method of claim 1, wherein the aggregate field value is a function of the values of a plurality of fields in a given record.

9. The computer implemented method of claim 8, wherein the function is a mathematical function.

10. The computer implemented method of claim 9, wherein mathematical function is sum.

11. The computer implemented method of claim 1, wherein the aggregate field value is a function of the values of a specific field in a plurality of records.

12. The computer implemented method of claim 11, wherein the function is a mathematical function.

13. The computer implemented method of claim 12, wherein mathematical function is sum.

14. A computer-implemented method of generating a user-defined rule relative to an aggregate field, the method comprising:
receiving an indication from a user for selecting a plurality of fields from at least one table;
receiving an indication from the user relative to a function to apply to contents of the plurality of fields from the table;
receiving rule information from the user, the rule information comprising criteria, which when satisfied, cause the rule to fire, and alert information defining an alert generated when the rule fires; and
storing the indication for selecting the plurality of fields, the function and the rule information.

15. The method of claim 14, wherein the plurality of fields include a specific field from a plurality of records.

16. The method of claim 14, wherein the plurality of fields are selected relative to a single record.

17. The method of claim 14, wherein the function is sum.

18. The method of claim 17, wherein the rule includes criteria causing it to fire when the sum passes a selected threshold.

19. A computer-readable medium having data structures stored thereon, the data structure comprising:
an aggregate field portion indicating selection criteria for selecting a plurality of fields from at least one table;
a function portion for indicating a mathematical function to apply to the selected field contents; and
a rule portion for storing at least one rule relative to the aggregate field value.

20. The computer-readable medium of claim 18, and further comprising an ignore portion for suppressing rule firing for at least some atomic changes that satisfy the at least one rule.
